(19) United States
(12) Patent Application Publication
(10) Pub. No.: US 2002/0198774 A1
(43) Pub. Date: Dec. 26, 2002

(54) Computer system and method to automate the shipping market and wireless marketing services for consumers

(76) Inventor: John Paul Weirich, Walnut Creek, CA (US)

Correspondence Address: JOHN WEIRICH, 524 KENDALL AVE #3, PALO ALTO, CA, 94306, US

(21) Appl. No.: 09/892,055

(22) Filed: Jun. 26, 2001

(51) Int. Cl. G06F 17/60

(52) U.S. Cl. 705/14; 705/37

(57) ABSTRACT

A computer based transportation system enables shippers to bid to move loads, from parties offering goods for sale to parties bidding to purchase those goods, using an automated auction system. Transportation costs are integrated into the prices of goods traded on the auction system. Additionally, consumers, including truckers and other transportation workers, are given the ability to obtain time-limited promotional messages using their cellphones and other devices which are in communication with the computer system described.

### TECHNICAL FIELD

This invention relates generally to the fields of internet auction markets, shipping transportation, and wireless device marketing services for consumers.

### BACKGROUND OF THE INVENTION

Transporters of goods operate in a competitive pricing market. Many truckers are free to quote bids for loads to fill their trucks. Likewise railroads, air freight companies, and marine shipping companies also quote bids to carry loads of goods over their delivery systems. Commonly these transportation companies are able to offer delivery prices that make economic sense to them, rather than having these prices set by an external authority such as a government or a price setting board. Thus there is a relatively freely fluctuating pricing market for shipping services, rather than set prices for these services.

There are many different ways that freight carriers contact potential customers for their transportation services. One way is that a customer brings a package to a storefront office that a carrier maintains. Another is if a customer phones the carrier and requests that a truck be sent to his location to pick up a load. Yet another way is if the customer delivers a package to the rail station for loading onto a freight train. Still another way is if a trucker delivers a cargo container to a port facility for placement on a ship. And so on. In each case, the customer for transportation services would be required to pay a fee for the services which is quoted or negotiated with the carrier. In many cases the carrier sets this transportation fee according to the fluctuating market rate.

The internet is a source of information for truckers to find loads and for people to find trucks offering transportation for their goods. The website truckstop.com allows truckers to search a list of loads waiting to be moved. Here the trucker finds a load with an origination and destination that matches his route preferences. Then he contacts the potential consumer of his transportation services and negotiates a hauling price with them. Similarly, a person who has a load that needs to be moved, can search a list of trucks that are available for hire. When he finds a truck that matches the type of truck he needs, for the schedule he needs, he contacts the trucker and negotiates a hauling deal.

Truckstop.com allows people to post loads of freight for hauling, modify the characteristics of those posts, and remove the posts altogether. People can either simply post the freight load, or post it in a special area to receive bids for hauling services from truckers. Thus truckstop.com has effectively established a free price market for freight loads. There are other websites that offer services similar to that offered by truckstop.com, as far as this regards listing freight loads awaiting shipment.

Another service available on the internet is auctions such as that offered on the eBay website. Here, people place items for sale to the highest bidder at expiration time. Another type of auction that is offered on the internet is the single price auction or call market auction. AZX Inc. offers single price auctions for stocks on its website.

A single price auction functions by setting a single settling price for the goods, at the market closing time, that results in the exchange of the largest volume of offers and bids, made at different prices, that have accumulated during the trading day. In economic terms, a single price auction sets the price of a good at the intersection of the supply and demand curves, as these curves are defined by the offers and bids for the good at different prices, as these are posted over the duration of the trading day. All offers to sell the good that are priced below or equal to the clearing price are taken, and all bids to buy the good priced above or equal to the clearing price are filled. The remaining offers and bids listed that day are left unfilled, and the largest volume of goods is exchanged at the final single settling price.

There are other websites that offer business-to-business auctions of special industrial goods like chemicals and metals and computer components, among many others. Examples of these sites are materialnet.com, metalsite.com, paperexchange.com, and plasticsnet.com. These sites, and others like them, generally provide a wide range of services to users which may include a highest bid auction market system, credit and insurance services, auction participant vetting, market news, and auction coordination.

Trafficop.com offers logistics management services to consumer and business-to-business auction sites using its iLink Global program. Users of their internet based service can obtain landed-cost shipping quotes and shipment handling and accounting services from them. iLink Global is clearly a service that is separate from the ecommerce auction sites.

It is clear that the internet offers a wide variety of sites where businesses and people can list their goods for sale through an auction. It is also clear that freight carriers can access particular internet websites to find freight loads to help fill their fleets of trucks, trains, airplanes, and ships. However, there is no single internet website that combines the operations of an auction market for goods of all kinds, with the operations of a market for shipping services for those goods sold in the auctions. Thus people and businesses who buy and sell goods in an auction must make arrangements with a shipping company for transportation of those goods in a separate transaction. They are not able to make their transportation services costs an integral part of the goods auction transaction.

Until now, there has not been an internet website that allows buyers and sellers of goods to achieve the better prices for their goods using an auction market, while simultaneously obtaining a lower cost of transporting those goods, by means of employing an integral open bidding market for freight carrier shipping services.

Internet websites like Directcoupons.com and Hotcoupons.com supply consumers with discount coupons which they can print out and carry with them to present to merchants when they make purchases. Also a great number of websites provide wireless application protocol (WAP) content so people can access the website using their cellular phones. Wapsilon.com and Delta-air.com are two examples of such sites. Further, department stores such as Kmart offer time constrained “blue light specials” price discount sales on selected items, whereby shoppers in the store pay lower prices if they purchase the product at that particular time.

Until now, no internet website has provided consumers with price discount services accessible using a cellular phone just at the time the customer physically arrives at the merchant's place of business. In other words, one aspect of the internet system described here provides consumers with time constrained price discounts which they can access through their cellphones, to use during a visit to a truckstop or other place of business.

As as result of the situation just described, users of internet auction markets have never derived the benefit of lower transportation costs forthcoming when the auction market is combined with an open bidding market for shipping the goods exchanged in the auctions. Additionally, truckers and other consumers have not benefited from lower prices that would result from being able to access instantaneous just-in-time price discount service programs using their cellphones while visiting a merchant.

### SUMMARY OF INVENTION

The present invention advantageously fills the aforementioned deficiencies in the prior art, by providing an internet website system which combines the operations of an auction market for goods, with the operations of an open bidding market for shipping services for the transference of freight loads from the origination location of the goods to the destination location of the goods, with price discount services for consumers that are accessible by cellphone and other portable digital assistant devices (PDAs).

In one aspect of the invention, an internet system is provided for freight carriers to bid for the right to transport the goods sold in the auctions conducted on the website. Another aspect of the invention provides a WAP based system for consumers that allows them to access discounted price services, offered by merchants, by using their cellphones and PDAs as the consumers approach the vicinity of the merchant's business. These price discount services are time-limited.

An embodiment of the present invention combines the auction system and shipping services bidding system and the WAP based price discount time constrained services into a unified internet website market system. This summary is not intended to ascribe limits to the present invention in any way.

### BRIEF DESCRIPTION OF THE DRAWINGS

FIG. 1 is a diagram of a personal computer connected to the internet.

FIG. 2 is a flow chart of the operations of a highest bid auction.

FIG. 3 is an illustration of a single price auction board.

FIG. 4 is a flow chart of the operations of a single price auction.

FIG. 5 is a diagram of computer terminals connected to the internet.

FIG. 6 is a flow chart of the operations of an internet auction system.

FIG. 7 is a flow chart of the operations of an internet auction system.

FIG. 8 is a flow chart of the operations of an internet shipping system.

FIG. 9 is an illustration of a bidding board for freight load shipping.

FIG. 10A is a flow chart of the operations of a combined shipping and auction system.

FIG. 10B is a flow chart of the operations of a combined shipping and auction system.

FIG. 11 is a flow chart of the operations of a combined shipping and auction system.

FIG. 12 is a diagram of a WAP network of cellphones connected to the internet.

FIG. 13 is a partial front view of a cellphone.

FIG. 14 is a flowchart of the operations of the price discount system.

FIG. 15 is a flowchart of the operations of the price discount system.

FIG. 16 is a flowchart of the operations of the price discount system.

FIG. 17 is a flowchart of the operations of the price discount system.

### DETAILED DESCRIPTION OF THE PREFERRED EMBODIMENTS

Referring now to the drawings, it is common for a person to access the internet using a personal computer as shown in FIG. 1, which presents a diagram of a typical arrangement of a system that could be used to access the internet.

The personal computer 2 has a modem 4 connected to it. The modem 4 has a connection to an internet service provider 8 through the telephone system 6. The internet service provider 8 is connected to a server farm 10 of computers, that can run software applications, through the cable system 12. Such a server farm 10 could run the software programs that implement the auction markets for goods and shipping services mentioned in the summary above.

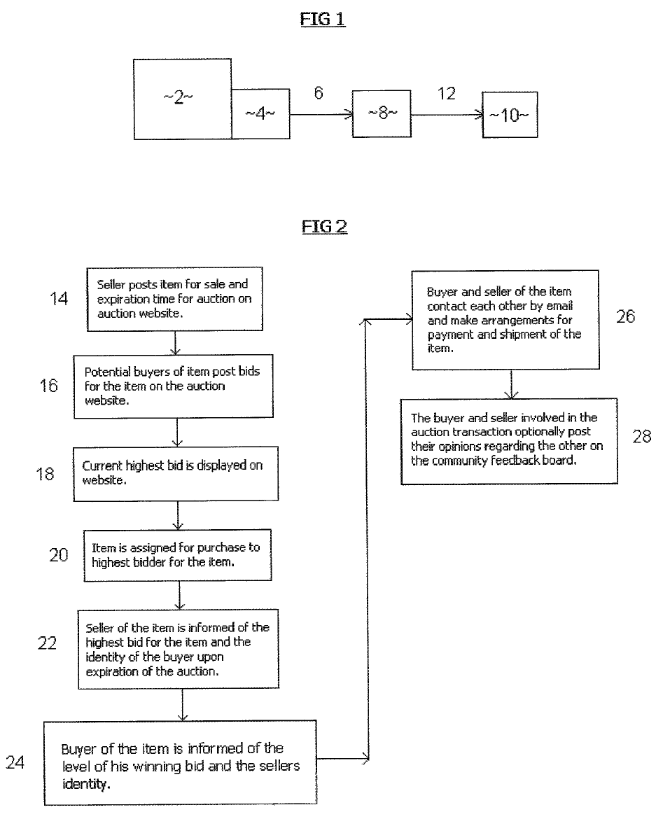

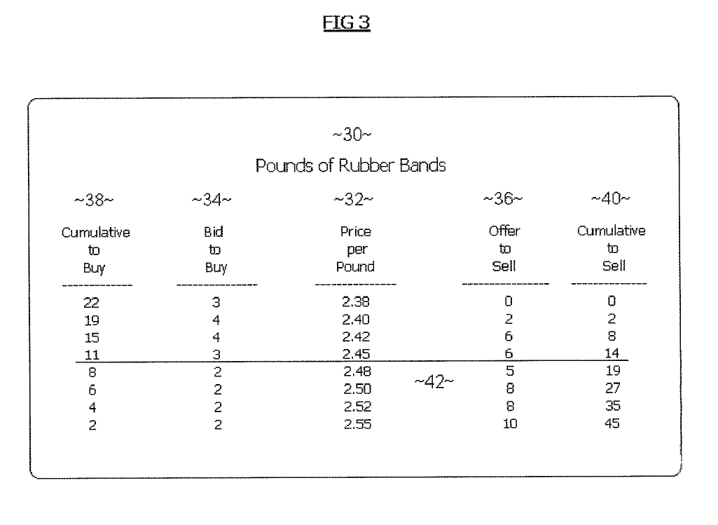

FIG. 2 shows the steps that are followed to sell an item in a highest price auction on an internet auction website. This is typical of the procedure followed when selling an item on a website like eBay or uBid. First the seller of the item posts a description of the item for sale on the website 14. Then people interested in buying the item post their bids on the website 16. Each bid must be higher than the prior bid or it is not accepted as the current bid 18. When the ending time for the item auction arrives, the current highest offer is accepted 20 and that bidder is designated to buy the item. At this point, the seller of the item is informed of the winning bid price and the identity of the buyer 22 by email. Also the winning buyer is informed of the identity of the seller 24. Now the buyer and seller would email each other to arrange for payment and delivery of the item 26. Finally, each could post their opinions of each other on the community feedback bulletin board 28, if they choose.

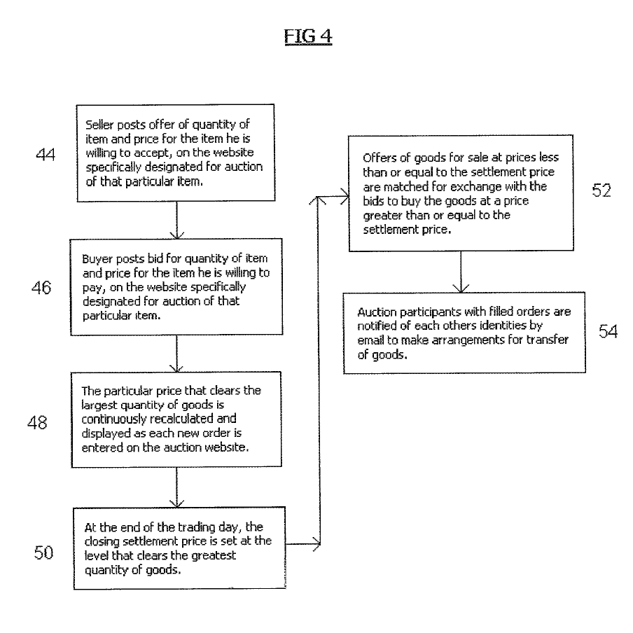

FIG. 3 presents an embodiment of what a single price auction board looks like on a computer screen. The item for auction is described at the top of the screen 30. The price levels of the bids and offers for the items are shown in the center column 32. The Bid to Buy column 34 shows the total quantity wanted for purchase at the particular price levels 32. The Offer to Sell column 36 shows the total quantity proffered for sale at the particular price levels. Then the Cumulative to Buy 38 and Cumulative to Sell 40 are the summations of the quantities reported in the Bid to Buy 34 and Offer to Sell 36 columns, respectively, at the particular price levels 32. The underlined row 42 is the settling price which clears the greatest quantity of goods in the market. In this example the settling price is $2.45 per pound of rubber bands which clears 11 pounds.

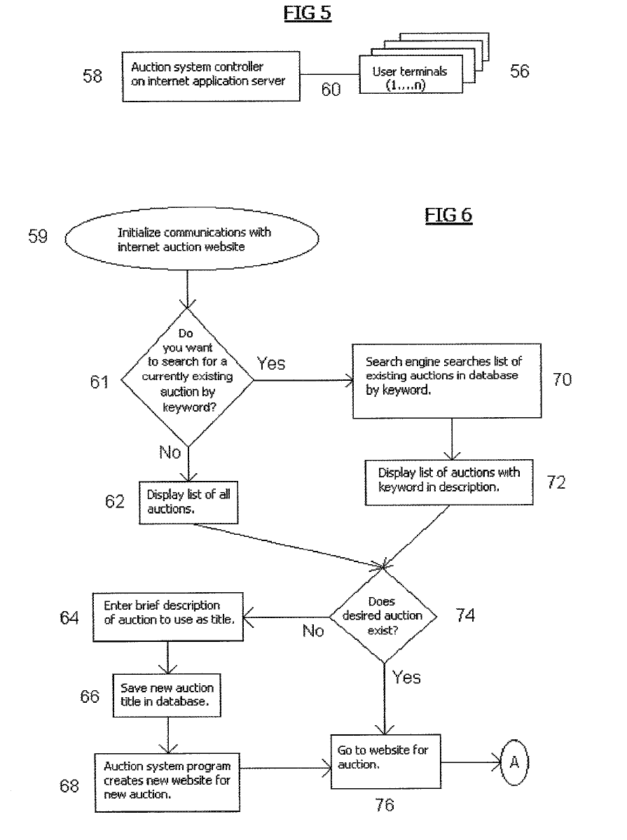

FIG. 4 shows the operations of a single price auction. Many consider a single price auction a useful method for selling large quantities of the same goods such as grain or wood, or a similar commodity good. The single price established at the end of the trading day is considered to be a fair price for market participants. Here is how a single price auction could operate on an internet website.

At any time, a person wanting to sell a good would go to the website page location specifically designed for the auction of that particular good, and list the quantity of the good for sale and the price he would accept for the good 44. Also at any time, a person wanting to purchase the good would go to the website page devoted to its auction, and post the quantity desired to buy and the price he or she is willing to pay for it 46.

Once the market opens for the day, the settling price that clears the greatest volume of goods is recalculated continually 48. This settling price is the price where the cumulative quantity of offers to sell the good at a price less than or equal to the settling price, is at least equal to the cumulative quantity of bids to buy the good at a price which is equal to or higher than the settling price, and this cumulative quantity is at its maximum level. In other words, this is the price at which the maximum quantity of the good would be exchanged by market participants at the price, or a better price, than they have bid or offered. Market participants whose orders' prices fall outside of these ranges just described, do not have their orders filled that day.

At the end of the trading day the final settling price is set 50. Offers to sell with prices less than or equal to the settling price are filled to the maximum extent possible, and bids to buy with prices above or equal to the settling price are filled 52 to the maximum extent possible. In economic terms, the settling price is the equilibrium price at the intersection point of the supply and demand curves as it exists on that trading day for that good.

Upon determination of the orders that are filled and those that aren't filled, email messages are sent to all market participants informing them of their order's status 54. Those people with filled orders are informed of each others' identities so they can make arrangements for payment and delivery of the goods.

FIG. 5 shows how a plurality of one or more terminals 56, typically personal computers, are connected to the system controller 58 for the auction system and shipping services bidding system. The terminals and system controller are connected through cable system 60. Typically the system controller 58 would be comprised of a farm of server computers maintained by an internet service provider. The software program application that provides all of the features needed to implement the auction and shipping services, runs on these application server computers along with, and as a part of, the whole controller system 58.

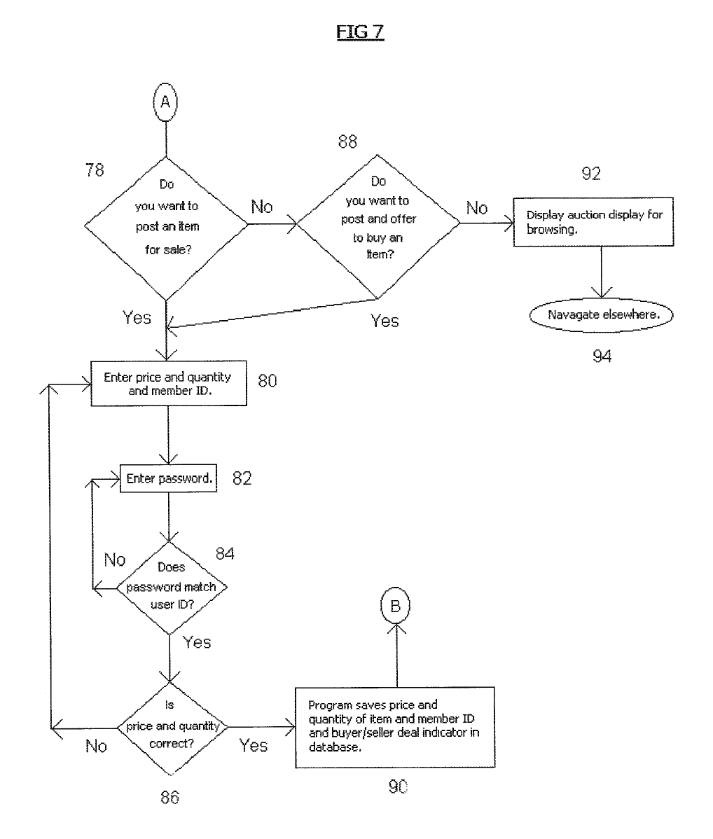

FIG. 6 illustrates the steps a user of the auction system could would follow to either create a new auction site to sell an item, or locate an already existing auction site he wishes to use. First the user logs on to the internet and navigates to the auction services website 59. There he or she would decide to locate an already existing auction 61 by doing a keyword search of a list of auctions that has been stored in a database 70. The search engine identifies all existing auctions in the list containing the keyword(s) and display these to the user 72. At this point the user would examine the titles of the auctions containing his keyword(s) to determine if any of them is what he wants 74. If he finds one that interests him, he selects it from the list and is automatically transferred to that auction's website 76.

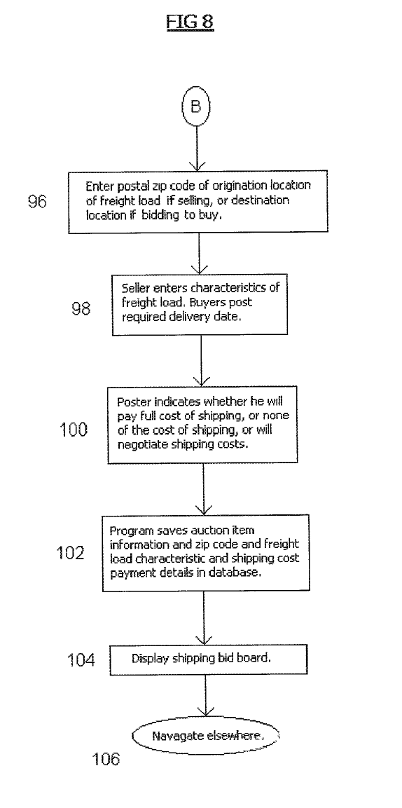

Alternatively, if the user does not want to use a keyword search 61, then he or she can choose to view a list of existing auctions stored in a database 62. The user examines the list of existing auctions to determine whether the one he wants exists 74. If the desired auction does not exist, then the user creates it using the auction system program. A new auction is created by entering a brief description of the auction that is used as the title for the auction 64, which is saved in a database by the program 66. Then the program creates a new website for the auction 68 and displays this website waiting for the user to enter his data to begin the auction 76. At this point the system advances along path A to step 78 as shown in FIG. 7.

FIG. 7 shows a flowchart of the steps taken by a user to enter data into an auction. Initially, upon entering the auction website, the user specifies if she or she wants to post an item for sale 78. If he does, then he enters the price and quantity of the item he wants to sell and also enters his member ID 80.

The member ID is an alias name that the user selects when he or she registers for membership in the website community. The user employs this member ID to distinguish himself whenever he uses the website. Each member ID is unique and is used by the program to link the member with his real world identification information such as name, address, phone number, and email address.

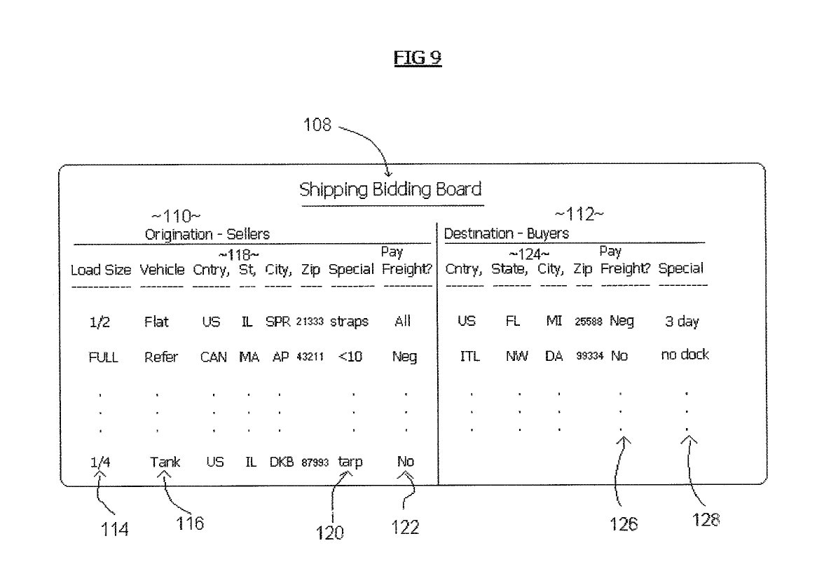

To verify the potential offer to sell, the user then enters his confidential password 82, which is immediately cross-checked with his member ID by the program 84. If there is a mismatch then the user must re-enter the password 82. If the member ID and password match, then the user is prompted to reconfirm the quantity and price of the item offered for sale 86. If these are not correct then they must be re-entered 80. If the price and quantity are correct then the program saves all of the information regarding the sale in a database 90. Here the program proceeds along path B to step 96 shown in FIG. 8.

An alternative is that the user wishes to buy an item 88 rather than sell it 78. In this case the user would enter the price and quantity of the item he wants to purchase 80 along with his member ID. Here the program follows the same steps described above proceeding at step 82. At step 90 the program would indicate that a buy had been entered in the system rather than a sale. Here the program proceeds along path B to step 96 shown in FIG. 8.

Another alternative is that the user wants to simply browse the information for the auction. Here the program would display the auction web page 92 for the user to view. Then the user would navigate to another web location when finished viewing 94.

FIG. 8 shows the steps involved supplying the program with additional information required for the auction transaction. The user enters the postal zip code for the origination location of the freight load if he or she is a seller of the item 96. Similarly, if he is offering to purchase the item, then he would enter the zip code for the destination location for the load 96. Freight load carriers use this locational information to estimate the costs of transporting loads from the origination to the destination points. Also sellers must enter details regarding characteristics of the load related to the item they are offering for sale 98. These could include things like the type of vehicle needed, the volume and weight of the load, the pickup date, and any other special characteristics of importance. Similarly, buyers must specify a delivery date for the item they are bidding for 98.

Information is also needed regarding who will pay shipping charges. This information is used to calculate the net price offered or received for the item. It is also used by carriers to identify loads they may want to bid for and transport. Therefore the poster must indicate whether he will pay all of the shipping cost for the load, or none of the cost, or will negotiate the splitting of shipping costs with the other party in the trade 100.

Once all of these details are entered by the user, the program saves them in a database 102 and displays the shipping bidding system on the website for the user to view 104. The shipping bidding system display lists the member IDs and locations, and puts these lists in separate columns indicating sellers and buyers. Such a formatted display assists carriers in identifying potential shipping deals. Once the user is finished viewing the shipping board, he would navigate elsewhere 106.

FIG. 9 presents an illustration of a shipping bidding board as it appears on a computer screen. The bidding board 108 is comprised into two parts, the left half displays the load information for the sellers' origination details 110, and the right half displays the buyers' destination details 112. The load origination information 110 includes the size of the load 114, the type of vehicle needed to transport the load 116, the pickup location 118, any important characteristics that could affect the job 120, and who will pay the freight costs 122. The destination information 112 includes the drop-off location 124, who pays the freight costs 126, and any important characteristics that could affect the job 128.

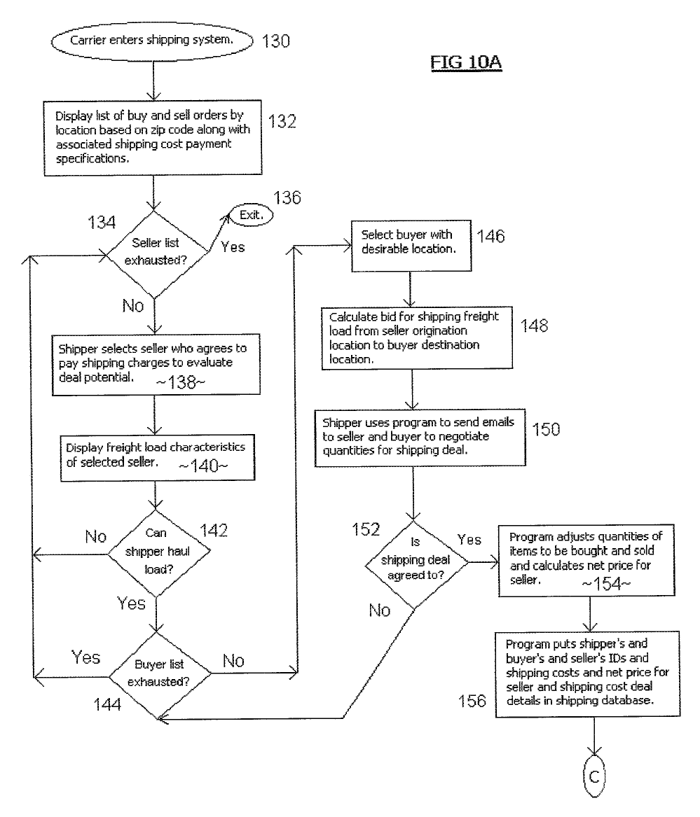

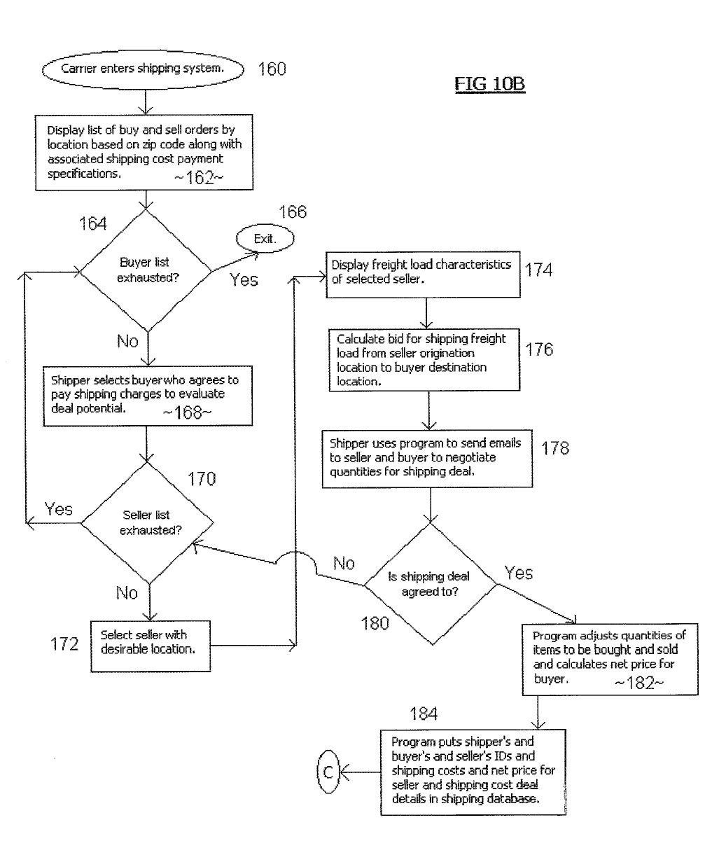

FIG. 10A presents a flow chart of the steps that a freight carrier follows to make a bid for a freight load using the shipping bidding system. Initially the member carrier logs into the internet and navigates to the shipping bidding system website 130. This site displays lists of the buyers and sellers participating in a particular auction by location 132 and FIG. 9. Additionally it displays the shipping cost payment plan specified by that buyer or seller as described in FIG. 8 step 100.

Upon examining these lists, a carrier could select a seller 134, who agrees to pay all shipping charges 138 to evaluate whether he could potentially make a shipping deal with this seller. Upon selecting this seller, the program displays the characteristics of the freight load, as described in FIG. 8 step 98, to the user 140. Then, using this information, the carrier proceeds to reckon whether he may want to propose a shipping deal with this seller 142. If the shipper cannot haul the load 142, then he or she checks to see if there is another seller on the list 134. If the seller list is exhausted then the user navigates elsewhere 136.

The carrier now looks to see if there are any buyers for the auction item 144. If there are, he would select one who has a destination location that is useful to him 146. At this point the carrier has enough information to calculate a bid to haul the freight from the origination to the destination 148. The carrier uses the shipping bidding program to send emails to either or both of the parties to negotiate a shipping deal with them 150. The details of the shipping deal include the shipping cost.

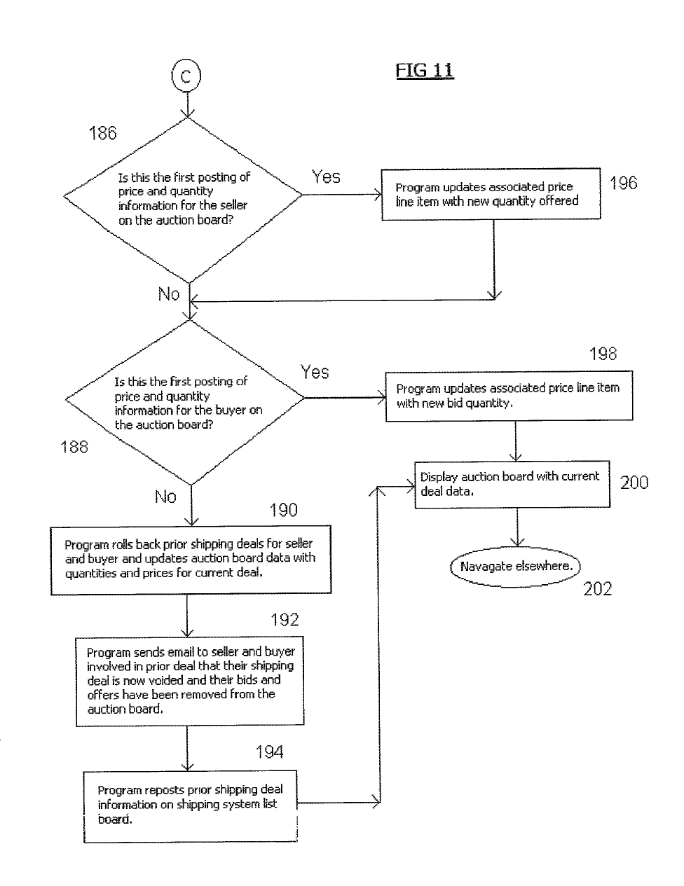

If the carrier negotiates a successful deal with the seller and/or buyer 152, the carrier indicates this to the system controller program and enters the quantities and costs involved in the transaction. The program uses this information in calculations to adjust the quantities offered for sale and bid to buy 154 for the members involved in the deal. The program also calculates a net price that the seller receives for his goods should they be sold at auction, based on the original price he posted minus the shipping costs just negotiated. Now the program saves all of this data in a database 156 and proceeds along path C to step 158 as shown in FIG. 11.

However, it could be that the carrier is not able to successfully negotiate a shipping deal with the current seller-buyer combination 152. In this case the carrier picks another buyer with whom to try to negotiate a deal, if there are any more buyers 144. If the list of potential deal making buyers is exhausted, then the carrier goes to step 134 to select a different seller. If there are no more sellers, then the carrier navigates elsewhere 136.

The flow chart of steps displayed in FIG. 10B is somewhat similar to those given by FIG. 10A except that the roles of buyer and seller are reversed. Here the carrier enters the shipping system 160 and examines the list of buy and sell orders 162 as in FIG. 10A. In this case he selects a buyer 164 who agrees to pay all shipping costs 168. Then the carrier proceeds to select an attractive seller 170, 172, and 174 who he could make a shipping deal with. The steps of calculating a shipping services bid 176, negotiating with affected parties to make a deal 178 and 180, recalculating quantities and net prices 182, and saving the information in the database 184, are nearly identical to those related steps described above for FIG. 10A. Now the program proceeds along path C to step 186 as shown in FIG. 11.

At this point the matched pair of buyer and seller have been joined by the carrier's shipping deal. The quantity of the auction item has been specified and the shipping cost for the load has been negotiated which allows the controlling program to calculate the net price of the item.

FIG. 11 presents the steps followed by the controller program to update the shipping bid board FIG. 9 and the auction board. Assume we are referring to single price auction board FIG. 3 for this example. If this is the first time that the seller's quantity and net price is to be added to the auction board 186, then the program updates the quantities displayed on the related net price line on the item's auction board web page 196. Similarly, if this is the first time the buyer's quantity and net price information are to be added to the auction board 188, then the program updates these amounts also 198. Now the auction board is displayed reflecting current price and quantity data 200 based on the current shipping deal. Then the user navigates elsewhere 202.

If this is not the initial posting for either the buyer's or seller's price and quantity data on the auction board, then it is necessary to roll back any already existing shipping deal, that is the immediately prior shipping deal, that either the seller or buyer had been included in 190.

This is because the seller and buyer are free to replace one shipping deal with a new superior deal from another carrier until the auction closes at the end of the trading day. This is the way freight carriers compete for business and shipping costs are driven down. It is possible that more than one carrier can have agreements with just one seller to haul his load for the same offer price. This is because each carrier would transport only part of the total quantity offered for sale by that one seller. However, it is against reason for two carriers to have an agreement with one seller to haul the same goods. Thus it is necessary to roll back any prior shipping deal commitments when a new preferable shipping deal is made.

Therefore the program accesses its shipping system database and rolls back any earlier shipping deals that would interfere with the current shipping deal 190. It also generates email messages to the buyers and sellers who were participants in these prior deals to inform them that they are no longer involved in the deals 192.

Then the program updates and reposts the information associated with these now canceled prior shipping deals, on the shipping system board 194 so it relists the current situation with the new preferable shipping deal just agreed to FIG. 10A 154 or FIG. 10B 182. Posting the quantities, locations, and other details for these loads on the shipping bidding board FIG. 9 allows renewed bidding for these newly available offers and bids. At this point the updated auction is displayed for the user's viewing 200, and the user can navigate elsewhere when satisfied 202.

Other alternative scenarios can be considered also. For example, it could be that neither the buyer nor seller involved in a shipping deal want to pay the full cost of shipping. In this case the negotiation shown in FIG. 10A at step 150 and FIG. 10B step 178 is completed with each of them paying part of the shipping cost and then both the offer price and bid price would have to be adjusted to a net price. Another scenario is that the shipping bidding system FIG. 9 has an additional facility that allows carriers to coordinate logistics with each other, such that different carriers would be responsible for hauling a freight load over shorter sub segments of a longer route.

Yet another scenario would occur if the auction specifically disallowed any consideration of shipping rates at all. This could occur if auction participants already knew sufficiently what the shipping costs were for an item, and they chose to run an auction by simply posting bids and offers. In this case sellers and buyers could pair up to exchange goods, upon closing of the auction, on a first-come first-served basis. That is, they would be responsible for contacting each other to arrange shipping after the auction closes. Each participant would rationally try to contact and negotiate a shipping deal with another party who would minimized their shipping cost.

A internet based computer system is described below which allows truckers and any other consumers access to time constrained discount prices on goods by using their cellphones or other wireless communication devices to access an internet website. Sometimes, this internet website system is referred to as the “just-in-time discount” system, and abbreviated “JITD” for clearer understanding of its description.

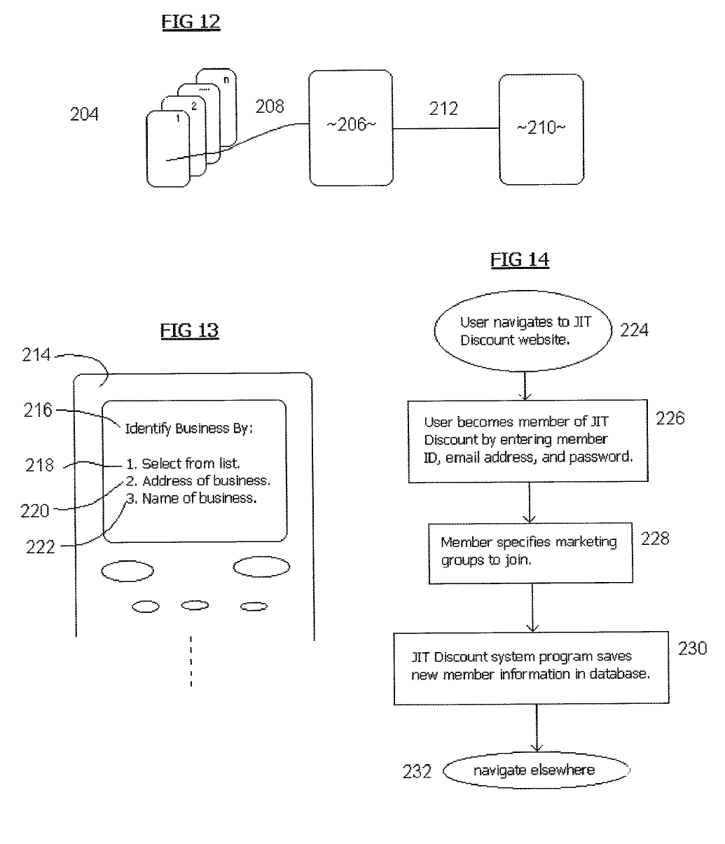

FIG. 12 shows a plurality of cellphones 204, or other portable digital assistant wireless terminal type of devices, in communication with a WAP gateway server computer 206, over a WAP wireless network 208. The WAP gateway server 206 is connected to an application server computer 210 over the internet protocol (IP) cable system 212. Such a networked computer system allows the cellphones 204 to send and receive data from the application server 210, thereby enabling the users of the cellphones to access and interact with internet websites which are hosted on server computers like 210.

The just-in-time discount (JITD) computer system allows consumers to access an internet website that provides them with special lower prices for goods that they may purchase while visiting a truckstop, store, or other place of business. The discount prices are time constrained. These time constraints are defined by the merchant when it sets-up its marketing program.

FIG. 13 is a front view of a cellphone 214 illustrating its LCD screen 216 and some buttons. The screen 216 displays three options—218, 220, 222—that a JITD member can choose from when he or she initially logs into the JITD website.

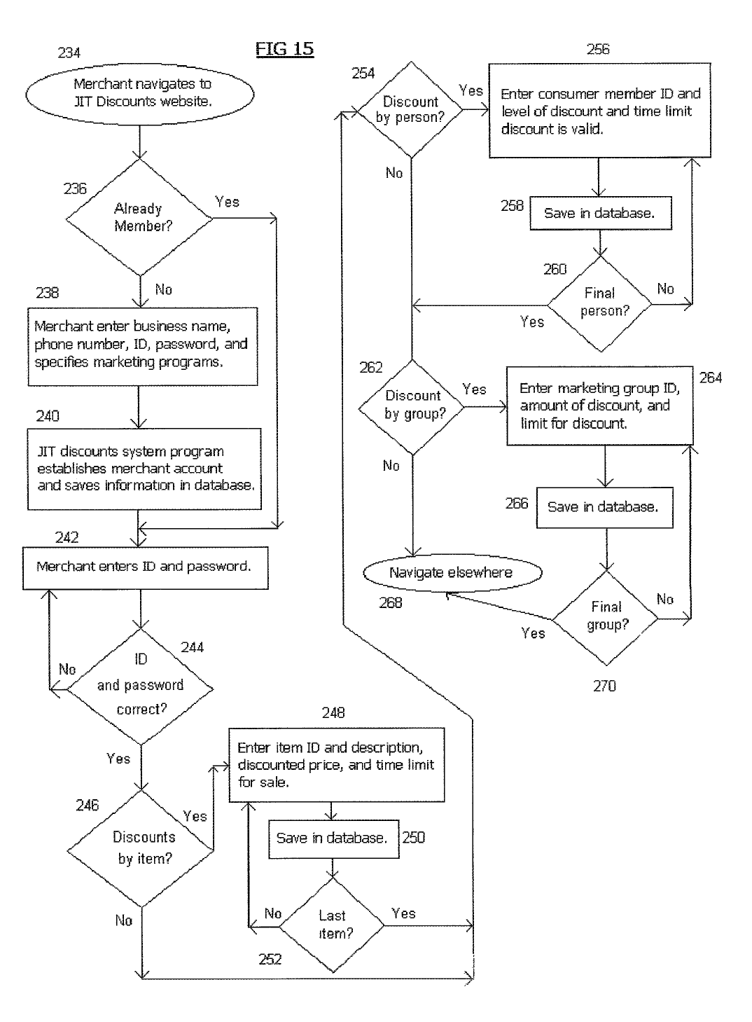

FIG. 14 lists the steps that an internet user completes to become a member of the JITD program. First he uses a device to navigate to the JITD website 224 available on the internet. Second he creates and enters a unique member ID and unique password and also supplies his email address 226. Third he or she indicates which special marketing programs he wants to join 228. For example, such marketing programs can target home owners, home workers, office workers, singles, couples, young people, retirees, pet owners, people who live in a particular location, among many others. Then the JITD system program creates a member account for the new member 230 and saves it in a database. Then the member navigates elsewhere 232.

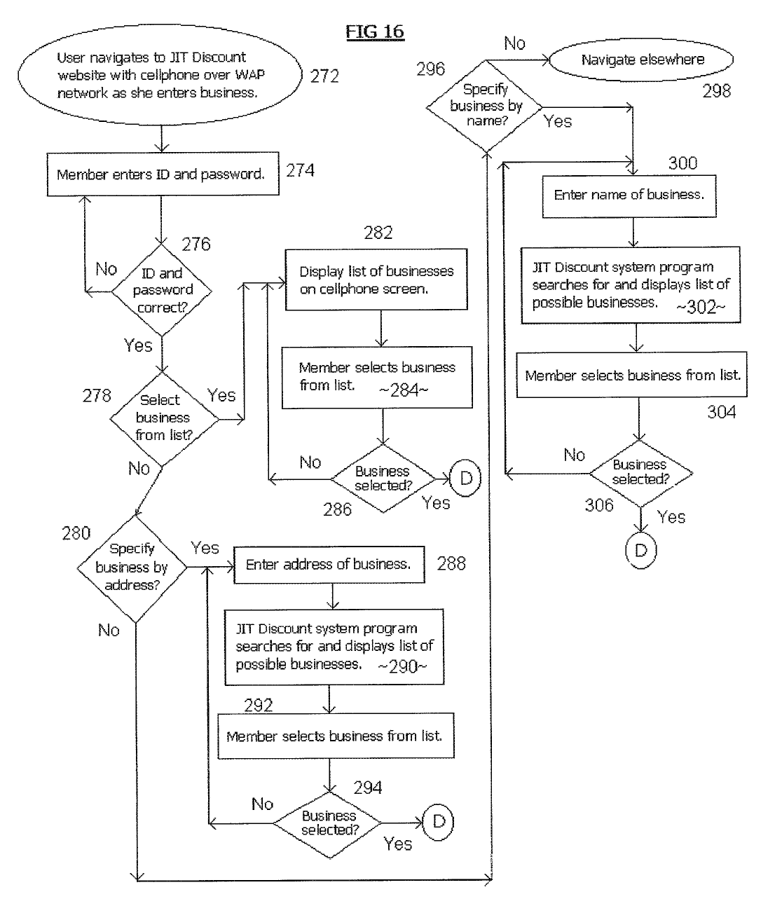

FIG. 15 lists the steps that a merchant follows to set-up a JITD account and/or marketing plans for consumers that may visit and make purchases at a place of business. Initially the merchant navigates to the JITD website using a computer or wireless communication device 234. If the merchant already has a JITD account 236, then he proceeds to enter his member ID and password 242. However, if the merchant wants to become a new member, then he enters the name and address of the business, its phone number, and unique member ID name and password. Also he specifies any particular marketing plans he wants to offer to customers like those described above for FIG. 14 step 228. Once this information is available, the system program saves it in a database and establishes the new merchant account.

Now the merchant enters his member ID name and password 242. If these are valid 244 he or she proceeds to supply information needed for the price discount programs. If the merchant wants to set-up or update price discount plans for particular items 246, then he enters a description and ID character string for the item and the length of time the item should be offered for sale.

For instance, the merchant might enter “Powells 4 AA Batteries”, “BPOWAA4”, “2.95”, “10MIN”, to indicate that four packs of Powells AA batteries are to be sold for $2.95 each, for a period of 10 minutes after the sale item is displayed to a customer on her cellphone. The customer is supposed to be physically in or close to the store when she calls to find out about the sale. The lower price rewards the customer for buying the item within the time constraint of 10 minutes of viewing the item on screen of her cellphone. And the merchant benefits by drawing customers to his store who are attracted by the exciting sale prices.

Here the sale information for that item is saved in the system database 250 and the sale information for the next item is entered. This continues until all sale information for all items 252 is saved in the JITD system database.

Now the merchant may decide that he wants to offer special sale prices to particular customers 254. For example, customers who shop frequently at his store would be given a special ten percent discount on items they by over the next week. So here he would enter the member name ID of the customer, the discount amount, and the length of time the sale prices apply. It's important to note that the member name ID the merchant enters to identify a customer is not necessarily the same member name that the customer uses to identify himself. In other words, the member name a merchant uses to identify a particular person to the JITD system, is probably not the same as the member name that that particular person uses to log into the JITD system. There are two different ID names for each person who is a member of JITD. This is to maintain confidentiality.

Now the sale information for the customer is saved in the JITD system database 258 and the merchant continues to enter sale information for each of the other customers who will be offered special lower prices 260.

The next step is to enter sale information for groups of members 262. Each member joined marketing groups when they joined the JITD community, FIG. 14 228. Here the merchant enters the level of price discount a particular marketing group should obtain and the time constraint for the sale. For example, an office supply store merchant could enter this information: “Home Office”, “15%”, “5 MIN”. This means that people who joined the work-at-home marketing group will get an automatic 15 percent discount on all goods if they buy them within 5 minutes of seeing the sale offer on their cellphones as they enter the store.

As the information for each marketing group is entered it is saved in the database 266, and the sale information for the next group is entered 270. Then the merchant navigates elsewhere 268.

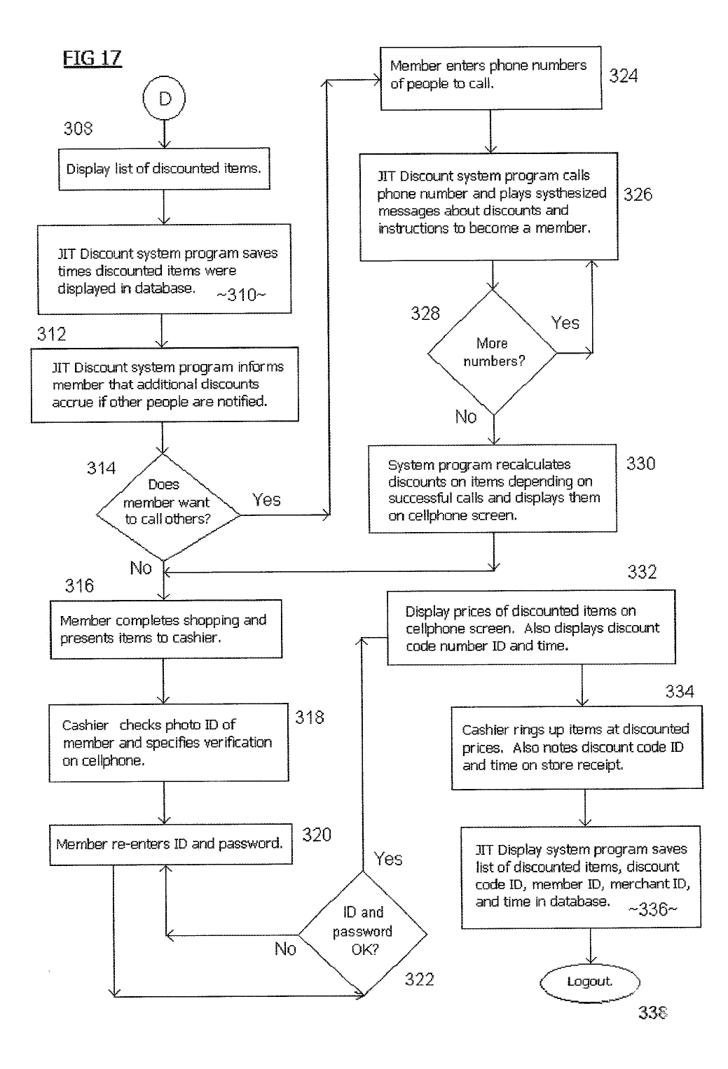

FIG. 16 shows the series of steps that are followed by a customer who wants to use the JITD system to get a price discount at a place of business. Initially the customer approaches the geographic location of the business and uses her cellphone to access the JITD internet website system 272. Then she enters her member ID and password 274 which are validated 276. Then the JITD system program displays the options shown in FIG. 13 on the screen of her cellphone. If she selects the first option, FIG. 13 218, FIG. 16 278, then JITD displays a list of businesses, that have been stored in its database, on the cellphone 282. Then the member selects the correct business from this list 284. If the member does not select a business from the current list 286, then another list is displayed, etc., until she selects a business. Then she proceeds on path D to step 308 in FIG. 17.

Alternatively, the member can identify the business by address 280 and FIG. 13 220. In this case she uses the keypad on the cellphone to relay the address of the business to the JITD system program 288. Then the JITD system program searches for businesses that have the exact address the member entered, or those with addresses that are close to the address she entered 290 and lists them on the cellphone display. Here the member selects the correct business from the list 292. If the business cannot be found 294, then she reenters a different address and goes through the process again. Otherwise she proceeds on path D to step 308 in FIG. 17.

A similar procedure is followed if the business is identified by name 296 and FIG. 13 222. Here the member enters the name of the business using the button pad 300. The JITD system program searches its database for businesses that have exactly the same name and names that closely resemble the name entered 302 and displays them on the cellphone. Now the member selects the correct business from the list and navigates down path D to step 308 in FIG. 17. If the member does not select a business 306, then she reenters a different name and goes through the process again 300.

Another alternative is that the cellphone is equipped with a global positioning system. In this case the shopper could simply press a button to send her exact geographic coordinates to the JITD system or she could key in her coordinates, using the button pad, and then transmit these to the system. Also the description above can be applied to any personal digital assistant (PDA) device as well as the cellphone, used for illustration.

Now that the business has been identified, the JITD system program searches the database FIG. 15 steps 250, 258, 266, for the items on sale at that store and displays them on the cellphone screen FIG. 17 308. The program also saves the time that these sale items are displayed 310 to the customer. The time is recorded so the program can determine the length of time that elapses between the time the sale items are first displayed to the customer member, and the time that the item is purchased at the checkout counter. This is to enforce the time constrained characteristic of the sale.

Now the JITD displays a message to the member that additional benefits can be earned for the member's account if the member identifies other people about the items for sale at the business he or she is visiting right now 312. These benefits could be many different things like additional price reductions for the items already offered for sale, frequent flyer miles, free cellphone airtime, free movie tickets, discounts at other stores, special account credits which can be turned in for prizes, or any other promotional item. For the purpose of illustration, assume these benefits are additional price reductions on current sale items.

If the member decides to allow others to be notified of the items for sale at the business 314, then she would enter the phone numbers of the people to call 324 on her cellphone. Once these phone numbers are entered and relayed to the JITD system, it executes a program that automatically calls the phone numbers 326 and plays an automated message informing the person of the items for sale at the store and how that person can become a member of the JITD website community also. The system program follows this procedure for each phone number entered by the member 328. Then the JITD system recalculates the price reductions on the items for sale to the member 330 depending on how many of the automated calls were successfully completed and displays the new lower discount prices to the member on the cellphone screen. A successful call could mean that someone listened to the message, or the intended recipient listened to the call, or the call recipient became a member of the JITD community, or other meanings.

Another alternative is that the JITD database system has already stored the phone numbers of the member's friends which were entered when he or she registered and signed up for the marketing plans, FIG. 14 228. Then she would simply indicate that the numbers on this stored list should be called, rather than enter each of the numbers herself 324.

Now the member completes her shopping and presents the items to the cashier 316. Now someone, the cashier or shopper, chooses the verification option on the cellphone and the JITD system prompts the shopper to reenter her member ID and password, while the cashier is watching 320. Also the cashier could ask the shopper for a photo ID to ensure her identity 318. If the member ID and password are correct 322, then the JITD system displays the discount prices for the items that are still apply, within the time constraints, and it also displays a unique code number ID for the transaction and the exact system time on the cellphone screen 332.

The cashier rings up the items with the discounted prices as shown on the cellphone screen. Also the cashier writes the transaction code number ID and time, as shown on the cellphone screen, right on the store receipt for the transaction 334. This is for auditing purposes if it is necessary, for some reason, to match the records of the JITD system with the store records. Now the JITD system program saves the information about the discounted items, the transaction code ID, the member ID, the merchant ID, and the time stamp in its database 336 for future processing if needed.

Then the customer logs out of the JITD website community system and leaves the business with her goods 338.

An alternative scenario to that described above is if the JITD system program and the business' computer system are linked in a network to allow them to exchange information instantaneously. In this case bar-codes could be displayed on the shoppers cellphone screen when she delivers her items to the cashier. These bar-codes could be read by the laser scanners mounted at the checkout line just like laser scanners are used to read the bar-codes printed on food packages. The bar-codes displayed on the cellphone screen provide access to pricing, time, and transaction information. Upon reading the barcode, the cash register computer system could access the price of the good from the networked JITD database or from its local copy of the pricing database. Another scenario would be that a character string is displayed on the cellphone screen, rather than a barcode. In this case the cashier would type the characters into the register and then the pricing database would be accessed using that string. An additional scenario is that the customer simply shows the cashier the discounted prices on her cellphone screen, and and the transaction verification steps 320, 322, 332, 334 are not followed, or only partially followed to the satisifaction of the merchant and customer. And there are many other alternative scenarios that accomplish the same task by similar means.

The many features and advantages of the present invention are apparent from the detailed specification, and thus, it is intended by the appended claims to cover all such features and advantages of the invention which fall within the true spirit and scope of the present invention.

Furthermore, since numerous modifications and variations will readily occur to those skilled in the art, it is not desired that the present invention be limited to the exact construction and operation illustrated and described herein, and accordingly, all suitable modifications and equivalents which may be resorted to are intended to fall within the scope of the claims.

I claim:

1. A method of delievering time-limited discount information for products offered for sale by businesses, comprising the steps of:
querying, using a cellphone in communication with a computer, a system to determine if a business has provided special time-limited discount listing information for products offered for sale;
transmitting, using a computer in communication with a cellphone, said special time-limited discount listing information to a cellphone, with said computer recording the time of this transmission;
viewing for the initial time, using a cellphone in communication with a computer, said time-limited discount listing information on a cellphone screen;
presenting for authorization, using a cellphone in communication with a computer, said special time-limited discount listing information for approval by said business;
transmitting said approval, using a cellphone in communication with a computer, by said business for a discount for a product during the processing of a sales transaction;
transmitting a message, using a computer in communication with a cellphone, to verify a discount for a product, when the time-limit for a discount for a product has not been exceeded since said viewing for the initial time; and
recording the time and discount information of said sales transaction, using a computer.

2. The method of claim 1, wherein said cellphone is replaced with a personal digital assistant type of device.

3. The method of claim 1, wherein said step of transmitting a message to verify a discount, is replaced by a step of transmitting a message, using a computer in communication with a cellphone, to not verify a discount for a product, when the time-limit for a discount for a product has been exceeded since said viewing for the initial time.

4. The method of claim 1, wherein said step of recording the time and discount information is performed prior to transmission of a verifying message.

5. A system comprising:
means for creating a special time-limited discount information listing for a product offered for sale for a business;
means for making available said special time-limited discount information listing via communication with wireless devices;
means for selecting a particular said business to display a special time-limited discount information listing for product offered for sale by said business;
means for providing authorization notification for a time-limited discount for a product offered for sale by said business; and
means for calculating the passage of time between an initial time a discount item is displayed for viewing and the time when authorization is granted for a discount.

6. The system of claim 5, wherein said product offered for sale, further includes a plurality of products offered for sale.

7. The system of claim 5, wherein said business, further includes a plurality of businesses.

8. The system of claim 5, wherein said special time-limited discount information listing, further includes a plurality of special time-limited discount information listings.

9. The system of claim 5, wherein said communication with wireless devices, further includes communication with wired devices.

10. A system comprising:
a memory device having embodied therein information relating to a plurality of special time-limited discount information listings for products offered for sale by businesses and authorization information for said products;
a processor in communication with said memory device, said processor configured to:
receive a request to select discount information for products offered for sale by a particular business;
format a listing of said select discount information for products offered for sale by a particular business;
transmit said formatted listing to other devices in communication with said processor;
receive requests to authorize discounts for said products for sale;
determine if authorization criteria for said products is satisified;
transmit authorization messages to devices in communication with said processor; and
store in said memory device information related to sales transactions for said products on discount;

11. A method of using a computer to process bids to transport goods offered for auction, comprising the steps of:
viewing special listing information for a good offered for auction including the origination pickup location, quantity, notable conditions, and price of said good along with an indication of whether shippers may place bids to transport said good from said origination pickup location to a delivery destination location;
viewing special listing information for a bid placed for a good offered for auction including a delivery destination location, notable conditions, and price of said good along with an indication of whether shippers may place bids to transport said good to said delivery destination location from said origination pickup location;
negotiating a shipping cost agreement with a shipper to transport said good offered for auction from said origination pickup location to said delivery destination location, specifying said quantity and circumstances of transport;
calculating a net price for said good offered for auction by subtracting said shipping cost from said price of good offered for auction, if the party offering said good for auction agrees with said shipper to pay some portion of said shipping cost;
calculating a net price for said bid placed for a good offered for auction by subtracting said shipping cost from said bid placed for a good offered for auction, if the party placing said bid for a good offered for auction agrees with said shipper to pay some portion of said shipping cost;
matching said good offered for auction and said bid for a good offered for auction into a binding agreement to transport said good from the origination pickup location to the delivery destination location;
setting the price said good offered for auction will be entered into the auction market to said net price if it was calculated in the step above;
setting the price of said bid placed for a good offered for auction will be entered into the auction market to said net price if it was calculated in the step above; and
entering said matching good offered for auction and bid for good offered at auction, into the auction market, at their respective price and quantity levels as calculated in the prior steps.

12. The method of claim 11, further comprising steps of:
matching a good that is already included in the auction market with a bid for a good;
negotiating a shipping cost agreement with a shipper to transport said good already in the auction from its origination pickup location to the delivery destination location for matching said bid for the good, specifying said quantity and circumstances of transport;
calculating the net prices of said good and matching said bid for the good as detailed in steps of claim 11;
setting the price of said good and matching said bid for the good will be entered into the auction market as detailed in steps of claim 11;
rolling back the original price and quantity entries, as detailed in the final step of claim 11, of said good offered for auction and said bid for the good offered for auction; and
entering said good and bid for the good, into the auction market, at their respective new price and quantity levels as calculated in the steps above in the current claim 12.

13. The method of claim 12, wherein the step of matching a good already included in the auction market, is replaced by matching a bid for a good that is already included in the auction market with a good that is offered for auction.

14. A system comprising:
means for creating an auction system for goods, said auction system further enabling inspection of details regarding said goods, said details including the geographic location of said goods and any special conditions of said goods;
means for bidding to ship goods traded on said auction system, with these shipping bidding means integral with said auction system; and
means to calculate adjusted prices for goods traded on said auction system as affected by bids to ship goods traded on said auction system.

15. The system of claim 14, further including means to make shipping agreements.

16. A system comprising:
a memory device having embodied therein information relating to a plurality goods and a plurality of shipping bids;
a processor in communication with said memory device, said processor configured to:
display a listing of said goods in an auction format;
display a listing of characteristic information about said goods;
display a listing of said shipping bids;
receive information relating to said goods and said shipping bids;
store information relating to said goods and said shipping bids;
perform calculations using information relating to said goods and said shipping bids; and
provide information about results of auctions and shipping agreements.
